(19) United States
(12) Patent Application Publication
(10) Pub. No.: US 2007/0227402 A1
(43) Pub. Date: Oct. 4, 2007

(54) Coating-Paper Composition and Method for the Preparation Thereof

(76) Inventor: Sai Hong Hui, Singapore (SG)

Correspondence Address: BIRCH STEWART KOLASCH & BIRCH, PO BOX 747, FALLS CHURCH, VA, 22040-0747, US

(21) Appl. No.: 11/587,649

(22) PCT Filed: Nov. 19, 2004
(86) PCT No.: PCT/SG04/00376

§ 371 Date: Oct. 26, 2006

(30) Foreign Application Priority Data
Apr. 27, 2004 (SG) 200402356-0

(51) Int. Cl. D21H 19/38; C08K 3/26

(52) U.S. Cl. 106/401; 427/209

(57) ABSTRACT

A coating composition comprising Nano-sized Precipitated Calcium Carbonate (NPCC) and at least one binder for coating support. The NPCC particles have a size of 10-100 nm, in particular 15-40 nm. More in particular, the average size of the NPCC particles is substantially 30 nm. Also provided is a method for making the coating composition and method to apply the coating composition on a support.

### FIELD OF THE INVENTION

The present invention relates to coating paper composition comprising Nano Precipitated Calcium Carbonate (NPCC) and to a method for the preparation thereof.

### BACKGROUND OF THE INVENTION

Pigments are used in papermaking and paper coating to improve the appearance, optical properties and printability of papers. Commonly used pigments include kaolin clay, zeolite, calcium carbonate, silica, titanium dioxide, alumina trihydrate and polystyrene. These pigments are useful in manufacture of conventional printing and writing papers and paperboards that are printed or imaged by common processes including offset lithography, gravure and xerography. Recently developed imaging technology has created needs for new types of coated and uncoated papers with properties not achievable with conventional pigments. Ink jet printing is a good example.

Ink jet printers have recently become the dominant digital printers used at home and office. As affordable ink-jet printers grow wider and faster, and tends to fill out market niches, there is an increasing request for multipurpose papers in order to fulfil the efficient use of these new printers and at the same time to meet the routine day to life application.

Most multipurpose papers on the market today are uncoated or surface sized grade. The cost of these papers is low due to the ever increase in speed of devices for making paper. However, while suitable for most routine application, these uncoated and standard surface sized grade papers do not allow for high end print and image appearance.

At the other extreme, there are high-gloss, high end papers, such as photographic ink jet papers. Ink jet printing technology has undergone several changes in addressing the demands of existing and future digital printing applications that require high quality printed images. High quality ink jet printing typically occurs on coated paper; therefore, to produce such high quality printed images the coating composition and the ink formulation must be considered.

The ever-lowering of the cost of the digital camera and the development of the photo handphones also help drive the demand for a higher quality and low-cost multi-purpose inkjet to meet the mass market demand. With the compositions for coating paper currently on the market, higher quality coated ink jet papers must be coated off-machine and are not cost effective. Producing a paper sheet with the desired properties is difficult due to the need to find ways to coat ink jet paper on-machine at commercial speeds with no loss in quality. The preferred finished ink jet paper should be smooth, strong, opaque, bright, and able to handle the demands of ink jet printing while providing excellent print results, such as excellent ink adherence, high scratch and ink resistance, and bleed control for sharp edges.

The need for ink jet quality papers that exhibit improved performance over basic uncoated papers or starch size press grade papers has led to an increase focus on matte papers for these applications. Matte papers consist of overcoat layer containing matte beads that provide ferrotyping and blocking protection. Until recently, nearly all ink jet matte finished papers coatings contained Amorphous Silica pigments-primary precipitated silica (PPT Silica), but also fumed and gel silica, in order to provide the required high capacity for ink liquids. While Silica is effective once it is on the paper, Silica pigments pose production problems so that the papers must be coated at relatively slow speed (i.e. off machine coating). The performance properties of PPt Silica are that of high ink receptivity and high brightness. However, the PPt Silica is expensive, low in density and may cause rheological problems.

Coating solids level is a major limiting factor with PPT Silica pigments because As a result of these factors, there is a need in this field of technology in producing low cost grade capable of being used to match the improved performance of ever improving home and office ink jet printers.

### SUMMARY OF THE INVENTION

The present invention addresses the problems above, and in particular to provide a new composition comprising Precipitated Calcium Carbonate (PCC) particles having the size of 10-100 nm, typically 15-40 nm, and at least one binder. The Precipitated Calcium Carbonate (PCC) particles having the size of 10-110 nm, in particular 15-40 nm, will be here referred to Nano Precipitated Calcium Carbonate (NPCC).

According to one aspect, the composition according to the invention is a composition for coating non-soluble support. A not limiting example of a solid support is a cellulose support. More in particular, the support is paper. The support comprises a topside and a backside.

According to another aspect, the support according to the invention is coated with the composition comprising NPCC and at least one binder on at least the topside or the backside or on both sides.

The NPCC particles have a size of 10-100 nm, in particular 15-40 nm. More in particular, the average size of the NPCC particles is substantially 30 nm. The NPCC particles could come in all shapes but in particular, have a cubic shape material. Accordingly, the composition of the invention comprises substantially cubic shape NPCC particles.

According to another aspect, the binder used for the preparation of the composition of the invention is a binder for paper coating composition.

In particular, the binder is selected from the group consisting of starch; oxidized starch; enzyme-converted starch; cationic modified oxide starch; amphoteric starch; synthetic polymer latexes; starches having hydroxyl, carboxyl, or amido group or groups; proteins; and their mixtures. However, the binder is not limited to this list. Another suitable binders evident to a skilled person may be used.

According to a particular aspect of the invention, the binder is starch. For example, oxidized starch. In particular, cationic modified oxide starch.

According to another aspect, the composition of the invention further comprises at least one of synthetic polymer latexes is polystyrene-acrylate, polystyrene-butadiene, polyvinyl acetate-acrylate, alkyl plyacrylates homo- and copolymers, or a mixer thereof.

According to another aspect, the invention provides a method for preparing a composition, comprising mixing the NPCC of the invention and at least a binder.

According to another aspect, it is provided a method of coating a surface of a non-soluble support comprising applying the coating composition of the invention on the surface of the surface of a non-soluble support.

The non-soluble support may be a cellulose-based support, in particular paper. For example, ink jet paper for printing.

The coating composition is applied on the support by any suitable method, for example by spraying the composition on the surface of the support and/or by size pressing.

According to another aspect, it is provided a coated support comprising a coating, comprising the NPCC of the invention and at least one binder, applied on a non-soluble support.

The coated support may coated on one or both sides.

### BRIEF DESCRIPTION OF THE FIGURES

FIG. 1 shows graph of a test wherein different NPCC coating compositions were prepared according to Example 2. The results of the printing test were obtained by using two printers, i.e. HP950, and EPSON 980.

FIG. 2 shows the size distribution of particles of NPCC.

### DETAILED DESCRIPTION OF THE INVENTION

Paper coating, which generally contains pigment, binders, and additives, is applied to the paper surface to improve the properties of the paper. The ink interacts with the coating to produce a high quality image. The coating prevents the ink from penetrating into the substrate. More specifically, the coating can optimise drying time for high water content dyes and separate the water-soluble organic dyes from the water vehicle and hold the dye on the surface so it doesn't strike through to the base sheet. Smoothness and thickness of the coating layer are two important physical properties that impact print quality. Pore structure and contact angle wettability effect print quality by preventing ink spreading. In order to prevent wicking and feathering, it is important that the thickness of the coating layer be homogenous to a scale of a few microns in depth which also helps in the absorption of successive droplets of ink at high delivery rates and any water present.

An important aspect of printing paper technology is the speed of production and the thickness of the layers and coating. Both aspects are important in view of the economy of the process of producing the photographic printing paper. The formation of crater defects, or pits, has turned out to be strongly dependent on those aspects.

The interactions between ink and the coated substrate play a vital role in producing images that are long lasting, well defined and of high strength regardless of printer application. The main interaction occurs at the surface of the substrate, where the type of bonding that occurs between the colorant and the media dictates the final print quality.

It has been attempted to increase the smoothness of the base paper by calendering the paper at high pressures between metallic rolls.

The paper must exhibit unique properties in order to produce a high quality printed image when the ink is fixed to the paper surface. Once the ink drop is accepted by the paper, the ink must adhere to the paper and spread minimally in all directions to generate sharp edges for print contrast and image fidelity. The paper must be smooth to give high print densities. In addition, the paper should minimize bleeding and wicking while promoting the absorption of ink to set the dye onto the coated surface since this promotes higher print densities. Ink jet droplets must be adsorbed quickly to avoid image smearing and multiple drop splatter. The dyes should be deposited near the paper surface to maximize colour density and contrast while minimizing show through.

Coated paper with a dull, no-gloss finish without luster is known as “matte finish”. Colours often appear softer on a matte finish. Until recently, nearly all ink jet matte finished paper coatings contained Amorphous Silica pigments-primary precipitated silica (e.g. the commercially sold products now in the U.S. market under the trade name of Sansil series sold by the PPG corporation), but also fumed and gel silica, in order to provide the required high capacity for ink liquids. While Silica is effective once it is on the paper, Silica pigments pose production problems properties as they must be coated at relative slow speed (i.e. using off machine coating). The key performance properties of Amouphous Silica offered are that of high ink “receptivity” and high brightness. However, Amorphous is expensive, low in density and may cause rheological problems.

Conventional Precipitated Calcium Carbon (PCC) available on the market has been used in paper manufacturing as sheet filler as well as conventional coating pigment. However, the PCC particles have size in the range of 1-10 μm (micron). The size of these particles is too big for the preparation of a coating pigment to be used efficiently in coating machines. In fact, PCC coating pigment is coated on the paper at relative slow speed. Some products comprising PCC are produced by milling down from the micron size PCC by mechanical force and have been used in reinforcing synthetic rubber and household paint application. However, the PCC normally have a broad particle size distribution and the supply quality is rather uneven.

Nano-sized Precipitated Calcium Carbonate (NPCC) consists of PCC particles having a size of nanometers. The size of the particles of resulted product is generally in the range of 10-100 nm (nanometers), in particular 15-40 nm, more in particular 30 nm. NPCC can be produced by reacting Carbon Dioxide and Lime under high speed mixing, precipitated ad separated by the rotatory bed technology (Synthesis of Nano CaCO3 in Novel RPB Reactor, Chemical Reaction Engineering & Technology, 1997, 13(2), 141-146; Synthesis and Characterisation of Nano Cubic CaCO3 particles in High Gravity Field, Chinese Journal of Chemical Physics, 1997, 10(5), 457-460; Synthesis of Nano Cubic CaCO3 Particles by HGRP, Powder Science & Technology, 1998, 4(4), 5-11) NPCC has been used as additive in combination with a dye in printing ink. The NPCC-401: Premium Grade Printing Ink is sold by NanoMaterials Technology, Singapore (http://www.sinonmc.com/corporatee/index.htm).

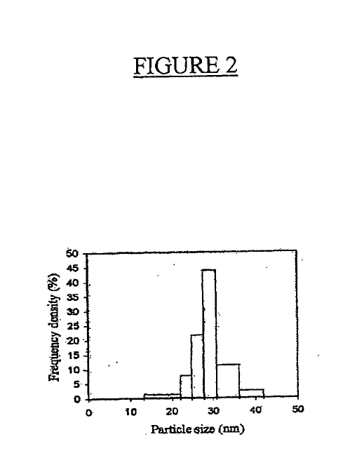

The particle size distribution of NPCC is shown in FIG. 2.

NPCC characteristics are shown in Table 1.

TABLE 1
NPCC SPECIFICATION

| Appearance | white powder |
|---|---|
| Particle shape | cube |
| Particle size (nm) | 15-40 |
| Whiteness (% ISO) | 90 |
| Surface Area (m2/g) | 30 |
| Ph | 8.5-10.0 |
| CaCO3 content (%) | 96.0 |
| Iron content (%) | 0.1 |
| Manganese content (%) | 0.008 |
| Insolubles (%) | 0.40 |

The present inventor has surprisingly found that NPCC can be used for the preparation of a composition useful, for example, as pigment in the ink jet printing industry.

Accordingly, the present invention provides a new composition comprising Precipitated Calcium Carbonate (PCC) particles having the size of 10-100 nm, in particular 15-40 nm, more in particular 30 nm, and at least one binder. The Precipitated Calcium Carbonate (PCC) particles having the size of 10-100 nm, in particular 15-40 nm, more in particular 30 nm, will be herein referred to Nano-size Precipitated Calcium Carbonate (NPCC).

In the more particular case, it is understood that the size of the NPPC particles comprised in the composition of the invention are essentially around 30 nm, in particular essentially 30 nm. With the term “essentially” it is meant that the majority of the NPCC particles have the size around 30 nm (see FIG. 2).

The composition of the invention can be used as coating and/or filler composition. In particular, the composition is a paper coating composition.

The binder comprised in the composition can be any commonly used binder for filling or coating composition. In particular, any binder known in the art as paper coating composition can be used. For example, binders disclosed in U.S. Pat. No. 4,544,609, herein incorporated by reference, can be used.

For example, the binder is selected from the group consisting of starch; oxidized starch; enzyme-converted starch; cationic modified oxide starch; amphoteric starch; synthetic polymer latexes; starches having hydroxyl, carboxyl, or amido group or groups; proteins; and their mixtures. In particular, the binder is starch. For example, oxidized starch, such as cationic modified oxide starch or amphoteric starch with charge more tilled to cationic charge.

This oxidized starch are made from hydrogen peroxide processes and enzymatic processes. Oxidized starch may also be made from tapioca root, corn and wheat. Any further starch suitable for the purpose of the present invention is also within the scope of the binder as herein used. Another type of starch that can also be used is the so called ink-jet starch which is essentially an amphoteric starch which leaned to the cationic side, i.e. oxidized starch with higher level of cationic group (out weight than that of the anionic group). Examples of several kind of starches, including oxidized starch suitable for the purpose of the present invention can be obtained from GPC (Grain Processing Corporation—http://www.grainprocessing.com/starch/paperinfo.html). Another possible starches are the so called “cationic wet-end starches”. Ink-jet starch and cationic wet-end starch may, for example, be purchased from Cerestar (http://www.cerestar.com). However, other low charge, low viscosity cationic starch can also be used.

The synthetic polymer latexes may be polystyrene-acrylate, polystyrene-butadiene, polyvinil acetate-acrylate, alkyl plyacrylates homo- or copolymers, or a mixer thereof.

The composition of the invention can be prepared by mixing NPCC particles and at least one binder according to any suitable method known in the art. For example, NPCC is dispersed in a binder solution, for example a well cooked binder solution (like a well cooked starch solution, i.e. the starch molecules are fully hydrated and dispersed evenly throughout the slurry). In this way, the solid content (that is, the amount of NPCC particles) represents no more than 50%. In particular, the amount of solid content is 10-50%, more in particular about 30% at a viscosity which is operable in a conventional manner as the typical mill size press operation.

The ratio of the mixture NPCC/binder should be more predominant toward binder by weight. In particular, for every part of NPCC 1.5-2.0 parts of binder should be used. For example, the ratio NPCC particles/binder is 1/1.5. However, any suitable ratio NPCC/binder evident to a skilled person may be used. This also in view of the particular use of the composition

The composition may further comprise inorganic dispersant and/or organic dispersant. The reason for using dispersant is to help the NPCC to disperse for evenly throughout the pigment-binder system. The inorganic dispersant may be pyropoly phosphorate salt(s). The organic dispersant may be low molecular weight (>7000 MW) polyacrylate. However, any other inorganic and/or organic dispersant known in the art and suitable for the purposes of the present composition may be used.

The composition may further comprise at least a thicken agent and/or a viscosity modifying agent. The viscosity modifying agent may be polyacrylate or any cross-linked polyols. The polyacrylate may cross-linked polyacrylate. However, any other thicken agent and/or viscosity modifying agent known in the art and suitable for the purpose of the present invention may be used. The thicken agent and/or viscosity modifying agent may also be added in order to adjust the viscosity of the composition. For example, to bring the viscosity of the composition to that of less of 1000 cps as measured in a Brookfield viscometer.

The composition of the invention is substantially in the form of particulate. In particular, the NPCC particulars have a cubic shape. The composition of the invention is not in the form of agglomerate like the PPT Silica, which is in large agglomerate form.

The composition of the invention may also comprise a dye.

With reference to the use of the composition of the invention as a coating composition, the coating composition is applied on a non-soluble support, for example a cellulose-based support. A cellulose-based support may be a paper, like printing paper, ink jet printing paper or photographic printing paper or other substrates of printed paper from the raw materials such as bygass (made from sugar cane waste), cotton, or synthetic fibers

The coating composition of the invention may be applied to only one side (topside or backside) or on both side of the support. For example, a matte finish paper is usually printable on both sides.

The coating composition of the invention may be applied on the support according to any method known in the art. For example, by spraying. The coating composition may also be size pressed on the support. Accordingly, suitable methods may be conventional spray bar, sophisticated Metered Size press, Sym Seizer (which is the trade name of a specially designed side press applicator produced by e.g. Voith corporation), Gate Roll, Meter Size Press, HSM, and/or Speedsizer. Size press equipment may be used to deposit the coating composition on to the fast moving support web, while it is still in its wet form, and prior to drying

“Size press” coating is generally carried out on high speed machine, wherein the amount of solid coating material is less than 30%, or on normal speed off machine (also known as “paper” coating), wherein the amount of solid coating material is more than 30%. The method of applying the coating composition further comprises drying the coating. The coating applied on the support may be dried according to any standard method known in the art. For example, by placing the coated sheet or paper inside an oven to dry at temperature up to 90° C. The temperature may be raised up to 110° C., however, in general, at no more than 150° C. Other methods of drying paper, like infra-red or air-drying, may also be used. After drying, the coating may further be subjected to calendaring, which is composed of a stack of stainless steel metal rolls, and/or polish treatment. This art is well-known in the paper industry.

Accordingly, the invention also provides a non soluble support coated with the coating composition of the invention. The support can be coated on only one side or on both sides. The support may be a cellulose-based support, or a support essentially based on cellulose. The support can be paper, for example printing paper, ink jet printing paper or photographic printing paper

A coated support according to the invention encompasses any support available in the art coated with the coating composition of the invention. The coating support also encompasses any available support in the art coated with the method according to the invention.

The NPCC particles, with their small size, 10-100 nm, in particular 15-40 nm, more in particular 30 nm, cubic shape material with slightly anionic and hydrophobic surface properties results to be an ideal for the preparation of coating composition (or ink jet pigment). Upon coated paper with a binder such as starch or other film forming latex emulsions via size press stage during the high speed paper making process, the pigment tends to migrate to the surface of the coated paper. Thus it will form a rather uniform agglomerated particulate layer on top of the paper surface. This thin layer of NPCC particulate will agglomerate on the coated surface to create a high number of ultra fine capillary channels on the top of the substrate, for example a paper substrate. As a result, the capacity of ink receptivities, optical brightness and opacity will greatly increase. Being so fine in size, the surface characteristic of the coated sheet shows particularly smoothness effect, which is ideal for the printing and writing grades.

Comparative physical properties of the NPCC used for the preparation of the composition according to the invention with known Pigment compositions in ink jet applications are shown in Table 2.

TABLE 2
Comparative Physical Properties of NPCC and Other Pigments Used in
Inkjet Applications:

| | | | Inkjet | Calcined |
|---|---|---|---|---|
| Pigment | NPCC | PPt Silica | Kaolin | Kaolin |
| Particle Size (m) | 15-40 (nm) | 1-10 μm | 1-2 μm | 0.7-0.9 μm |
| Pore vol. (cc./g) | N/A | 1.58 | 1.24 | 1.11 |
| Surface Area | 30 | 700-730 | 85-110 | 10-15 |
| (m²/gm) | | | | |
| Bulk Density | N/A | 7 | 25 | 13 |

NPCC can be purchased from one or more of the following producers:

GP NanoTechnology Group Limited (Enping, Guangdong), China;

Shandong Shengda Technology Co., Ltd (Mountain Tai Economy & Technology Developing Area) China;

NanoMaterials Technology Pte Ltd (Singapore).

Having now generally described the invention, the same will be more readibly understood through reference to the following examples which are provided by way of illustration, and are not intended to be limiting of the present invention.

### EXAMPLES

### Example 1

Preparation of Coating Composition

NPCC was purchased from GP NanoTechnology Group Limited (Enping, Guangdong, China).

Coating compositions were prepared according to the formulations herein below described.

Experimental Procedure for the preparation of the NPCC coating for composition (formulation) I):
a) 1.5 gram of oxidized starch (or ink jet starch, or amphoteric starch) was dissolved in 100 ml (gram of water);
b) the starch was stirred slowly and heated up to 60° C. in temperature;
c) after smooth slurry of a starch slurry has been achieved, the temperature of the slurry and pH were duly recorded. If the pH was below that of 6.0, caustic solution was used to adjust it back from 6.0 to 8.0;
d) 1.0 gram of the NPCC (nano-precipitated calcium carbonate) was well dispersed to the starch slurry with a low speed agitation;
e) when a homogeneous NPCC/starch solution has achieved, 25 ml of this NPCC/starch solution were spread over a commercially available base paper with basis weight of 80 gram. The size of the base paper was 0.25 meter square (m²);
f) the NPCC/starch slurry was uniformly spread over the cut size paper with a laboratory coating rod;
g) the resulted NPCC/starch coated sheet was then placed inside an oven to dry at temperature up to 90° C.;
h) upon drying the sheet was cut to feed into printer for optical density measurement and the results were noted.

The other three formulation were prepared according to the composition as below:

Formulation II): Water 100 gram (100 ml), NPCC 3.0 gram and oxidized starch 4.5 gram were used.

Formulation III): Water 100 gram (100 ml), NPCC 4.0 gram and oxidized starch 6.0 gram were used.

Formulation IV): Water 100 gram, NPCC 5.0 gram and oxidized starch 7.5 gram were used.

The coating formulations II), III) and IV) were applied on base paper using the same technique and procedure as described above for formulation I).

The starch used in the work was typically an oxidized starch with low viscosity or ink-jet starch. However, higher viscosity starch can also be used depending on the type of size press applicator that the paper machine is equipped with like gate roll, or SymSizer, or Meter size press, or the like.

### Example 2

The coating compositions were prepared and coated like in Example 1 and applied on plain printing papers and size pressed using a high speed size press coating.

The coated papers were test printed using two types of printers, i.e. HP 950, and EPSON 980.

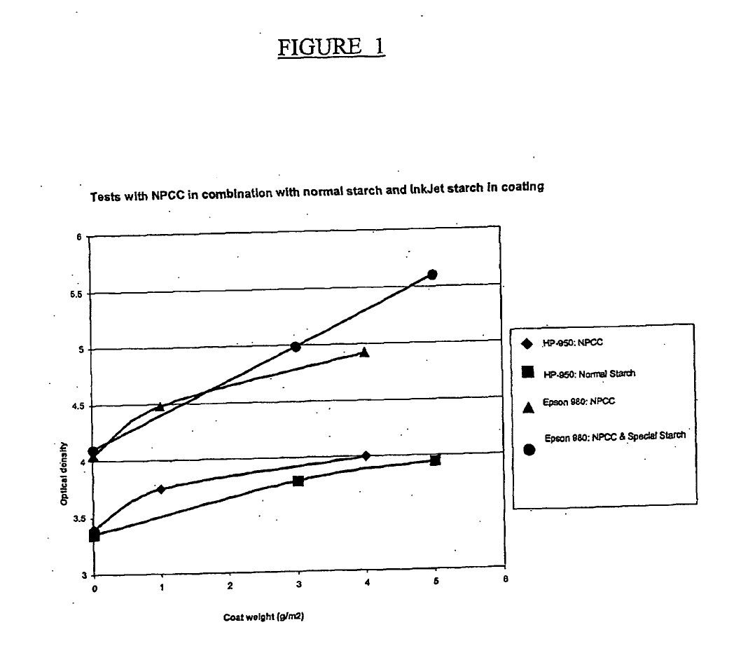

FIG. 1 shows a test where the papers were coated with compositions comprising:

(♦) NPCC; (▪) normal (oxidized) starch; (▴) NPCC; and (●) NPCC and ink-jet (special) starch.

The results of the test of FIG. 1 are also reported in Table 3. The optical density values, which were measured in the sum of CMY (cyan, magenta, yellow) relate to the colour intensity as well as sharpness of the image from 0 to 5.

TABLE 3
Summary of coat composition results

| | Experiments | | | | |
|---|---|---|---|---|---|
| | | (♦) | (▪) | (▴) | (●) |
| Optical Density - Sum | 0 | 3.4 | | | |
| of CMY (Cyan, Magenta, and | 1 | 3.75 | | | |
| Yellow) | 4 | 4.0 | | | |
| | 0 | | 3.35 | | |
| | 3 | | 3.8 | | |
| | 5 | | 3.95 | | |
| | 0 | | | 4.05 | |
| | 1 | | | 4.48 | |
| | 4 | | | 4.92 | |
| | 0 | | | | 4.1 |
| | 3 | | | | 4.985 |
| | 5 | | | | 5.6 |

The bleeding of ink was less than 1.0% and well below the 2.5% of standard acceptable level.

The optical density value which was a measure of sharpness of the colour image was substantially improved using an arbitrary scale of 0-5. In the test the coating comprising NPCC and ink-jet (special) starch (●) was compared to the coating comprising only (normal) starch (standard coating or prior art coating). Normally, the optical density decreases when the coating is applied. However, in the papers coated with the starch and NPCC, the optical density as depicted in FIG. 1 clearly showed an upward trends as the dosage level of NPCC increased. The results from FIG. 1 and Table 3 indicate the enhancement of ink receptivity due to the formation of NPCC pigments agglomerate at the paper surface and the formation of exceptionally high amount of capillary channels, which in turn increase the rapid ink receptivity during the ink-jet printing process.

1. A composition comprising Nano-sized Precipitated Calcium Carbonate (NPCC) particles having the size of 10-100 nm.

2. The composition of claim 1, wherein the NPCC particles have the size of 15-40 nm.

3. The composition of claims 1-2, wherein the NPCC particles have the average size of 30 nm.

4. The composition of claim 1-3, wherein the NPCC particles have substantially the size of 30 nm.

5. The composition of claims 1-4, wherein the composition is a coating composition.

6. The composition of claims 1-5, wherein the composition is a paper coating composition.

7. The composition of claims 1-6, wherein the binder is a binder for paper coating composition.

8. The composition of claims 1-7, wherein the binder is selected from the group consisting of starch; oxidized starch; enzyme-converted starch; cationic modified oxide starch; amphoteric starch; synthetic polymer latexes; starches having hydroxyl, carboxyl, or amido group or groups; proteins; and their mixtures.

9. The composition of claims 1-8, wherein the binder is starch.

10. The composition of claims 1-9, wherein the binder is oxidized starch.

11. The composition of claims 1-10, wherein the binder is cationic modified oxide starch.

12. The composition of claim 8, wherein synthetic polymer latexes is polystyrene-acrylate, polystyrere-butadiene, polyvinyl acetate-acrylate, alkyl plyacrylates, homo- or copolymers, or a mixer thereof.

13. The composition of claims 1-12, wherein the content of NPCC particles is not more than 50%.

14. The composition of claims 1-13, wherein the content of NPCC particles is 10-50%.

15. The composition of claims 1-14, wherein the content of NPCC particles is 30%.

16. The composition of claims 1-15, wherein the ratio NPCC particles/binder is 1/1.5-2.0.

17. The composition of claim 15, wherein the ratio NPCC particles/binder is 1/1.5.

18. The composition of claims 1-17, further comprising inorganic dispersant and/or organic dispersant.

19. The composition of claims 18, wherein the inorganic dispersant is pyropoly phosphorate salt.

20. The composition of claim 18, wherein the organic dispersant is polyacrylate having molecular weight >7000.

21. The composition of claims 1-20, further comprising at least a thicken agent and/or a viscosity modifying agent.

22. The composition of claim 21, wherein the viscosity modifying agent is polyacrylate.

23. The composition of claim 22, wherein the polyacrylate is cross-linked polyacrylate.

24. The composition of claims 1-23, wherein the viscosity is adjusted to less than 500 cps.

25. The composition of claims 1-24, wherein the composition is substantially in the form of particulate.

26. The composition of claims 1-25, which is not in the form of agglomerate.

27. The composition of claims 1-26, further comprising a pigment.

28. A method for preparing a composition according to any one of claims 1-27, comprising mixing Nano-sized Precipitated Calcium Carbonate (NPCC) particles having the size of 10-100 nm and the binder.

29. The method of claim 28, wherein the size of the NPCC particles is 15-40 nm.

30. The method of claim 28, wherein the NPCC particles have the average size of 30 nm.

31. The method of claim 28, wherein the NPCC particles have substantially the size of 30 nm.

32. The method of claims 28-31, wherein the NPCC particles have cubic shape and the composition is maintained in good separation due to the NPCC particle cubic shape.

33. The method of claims 28-32, comprising dispersing NPCC particles in the binder solution.

34. A method of coating a surface of a non-soluble support comprising applying the composition of any one of claims 1-27, on the surface of the surface of a non-soluble support.

35. The method of claim 34, further comprising drying the coating.

36. The method of claim 35, wherein the drying is carried out at a temperature no more than 150° C.

37. The method of claims 34-36, wherein the coating composition is applied by spraying the composition on the surface of the support.

38. The method of claims 34-37, wherein the coating composition is applied on the surface of the support by size pressing.

39. The method of claims 34-38, wherein the coating composition is applied on the surface of the support by bar spraying, metered size press and/or shim seizer.

40. The method of claims 34-39, wherein the dried coating is further subjected to calendaring and/or polish.

41. The method of claims 34-40, wherein the support is a cellulose-based support.

42. The method of claim 41, wherein the support is paper.

43. A coated support comprising a coating, comprising Nano-sized Precipitated Calcium Carbonate (NPCC) particles having the size of 10-100 nm and at least one binder, applied on a non-soluble support.

44. The coated support of claim 43, wherein the NPCC particles have the size of 15-40 nm.

45. The coated support of claim 43, wherein the NPCC particles have the average size of 30 nm.

46. The coated support of claim 43, wherein the NPCC particles have substantially the size of 30 nm.

47. A coated support prepared according to the method of any one of claims 34-46.

48. The coated support of claims 43-47, wherein the coated support is a coated cellulose-based support.

49. The coated support of claims 43-48, wherein the support is paper.

50. The coated support of claim 49, wherein the coated paper is ink-jet paper for printing.

51. The coated support of claims 43-50, wherein the support is coated on one or both sides.
